(19) United States
(12) Patent Application Publication
(10) Pub. No.: US 2017/0041769 A1
(43) Pub. Date: Feb. 9, 2017

(54) APPARATUS AND METHOD FOR PROVIDING NOTIFICATION

(71) Applicant: Samsung Electronics Co., Ltd., Gyeonggi-do (KR)

(72) Inventor: Sang Won SHIM, Incheon (KR)

(21) Appl. No.: 15/229,274

(22) Filed: Aug. 5, 2016

(30) Foreign Application Priority Data
Aug. 6, 2015 (KR) 10-2015-0111258

(51) Int. Cl. H04W 4/12; H04L 12/26; H04L 12/24; H04B 1/3827

(52) U.S. Cl. CPC H04W 4/12; H04B 1/385; H04L 43/10; H04L 41/0645

(57) ABSTRACT

An electronic device includes a display, a speaker, a vibrator, a memory for storing information and instructions for execution, and a processor coupled to the display, the speaker, the vibrator, and the memory, wherein the processor is configured to provide a notification associated with the information stored in the memory. The processor is configured to obtain a current value of the information, to compare the current value with a target value of the information, and to provide a notification of a first type via the display, the speaker or the vibrator when the current value is within a range of the target value and is not equal to the target value.

### CLAIM OF PRIORITY

This application claims the benefit under 35 U.S.C. §119(a) of a Korean patent application filed on Aug. 6, 2015 in the Korean Intellectual Property Office and assigned Serial number 10-2015-0111258, the entire disclosure of which is hereby incorporated by reference.

### TECHNICAL FIELD

The present disclosure relates to technology that provides a notification corresponding to specific information by an electronic device.

### BACKGROUND

With the development of electronic technologies, various types of electronic products have been developed and distributed. In particular, recently, interest in wearable electronic devices such as smart watches, smart glasses, or the like has increased.

Electronic devices such as smart watches provides the user with, for example, a variety of information such as time information, location information, environment information, biometric information, and the like. Moreover, to notify the user that time, location, etc. has reached a predetermined target value, the electronic device often provides the user with various notifications such as vibration notification, sound notification, or the like.

When providing the notification associated with certain information, such as time, the electronic device provides a notification where a current value of the information has reached a target value. In instances where the user sets a notification at a particular target time to perform an action, he or she often requires time to prepare for that action. Therefore only one notification at the target time may be insufficient. In addition, before the target time, it may be desirable to convey to the user additional information as the current time approaches the target time.

### SUMMARY

Aspects of the present disclosure are to address at least the above-mentioned problems and/or disadvantages and to provide at least the advantages described below. Accordingly, an aspect of the present disclosure is to provide an electronic device and a method that provide a notification such that the user recognizes whether the target value for the notification is approaching.

In accordance with an aspect of the present disclosure, an electronic device includes a display, a speaker, a vibrator, a memory for storing information and instructions for execution, and a processor coupled to the display, the speaker, the vibrator, and the memory, wherein the processor is configured to provide a notification associated with the information stored in the memory. The processor is configured to obtain a current value of the information, to compare the current value with a target value of the information, and to provide a notification of a first type via the display, the speaker or the vibrator when the current value is within a range of the target value and is not equal to the target value.

In accordance with an aspect of the present disclosure, a notification providing method of an electronic device includes obtaining a current value of information stored in the electronic device, comparing the current value with a target value of the information, and providing a notification of a first type when the current value is within a range of the target value and is not equal to the target value.

In accordance with an aspect of the present disclosure, a computer-readable recording medium has recorded thereon an instruction, which is executed by at least one processor, causing the processor to perform a method. The method includes obtaining a current value of information stored in the electronic device, comparing the current value with a target value of the information, and providing a notification of a first type when the current value is within a range of the target value and is not equal to the target value.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an operation of an electronic device, according to an embodiment of the present disclosure;

FIG. 2 illustrates another operation of an electronic device, according to an embodiment of the present disclosure;

FIG. 3 is a block diagram illustrating a configuration of an electronic device, according to an embodiment of the present disclosure;

FIG. 4 is a flowchart illustrating a notification providing method of an electronic device according to an embodiment of the present disclosure;

FIG. 5 is a flowchart illustrating a notification providing method of an electronic device according to another embodiment of the present disclosure;

FIG. 6A, FIG. 6B, FIG. 6C, FIG. 6D, FIG. 6E, FIG. 6F and FIG. 6G illustrate configurations of exemplary screens provided by an electronic device, according to various embodiments of the present disclosure;

FIG. 7 illustrates an electronic device in a network environment, according to various embodiments of the present disclosure;

FIG. 8 illustrates a block diagram of an electronic device, according to an embodiment of the present disclosure; and

FIG. 9 illustrates a block diagram of a program module, according to various embodiments of the present disclosure.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure disclosed herein, the expressions “have,” “may have,” “include,” and “comprise,” or “may include,” and “may comprise” used herein indicate existence of corresponding features (e.g., elements such as numeric values, functions, operations, or components) but do not exclude presence of additional features.

In the disclosure disclosed herein, the expressions “A or B,” “at least one of A or/and B,” or “one or more of A or/and B,” and the like used herein may include any and all combinations of one or more of the associated listed items. For example, the term “A or B,” “at least one of A and B,” or “at least one of A or B” may refer to all of the case (1) where at least one A is included, the case (2) where at least one B is included, or the case (3) where both of at least one A and at least one B are included.

The terms, such as “first,” “second,” and the like used herein may refer to various elements of various embodiments of the present disclosure, but do not limit the elements. For example, “a first user device” and “a second user device” indicate different user devices regardless of the order or priority. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for,” “having the capacity to,” “designed to,” “adapted to,” “made to,” or “capable of.” The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to one embodiment of the present disclosure, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or an implantable type (e.g., an implantable circuit).

According to another embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to one embodiment of the present disclosure, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global navigation satellite system (GNSS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or interne of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). According to one embodiment, the electronic device may be one of the above-described devices or a combination thereof. An electronic device according to an embodiment may be a flexible electronic device. Furthermore, an electronic device according to an embodiment may not be limited to the above-described electronic devices and may include other electronic devices and new electronic devices according to the development of technologies.

Hereinafter, electronic devices according to various embodiments of the present disclosure will be described with reference to the accompanying drawings. The term “user” used herein may refer to a person who uses an electronic device or may refer to a device (e.g., an artificial intelligence electronic device) that uses an electronic device.

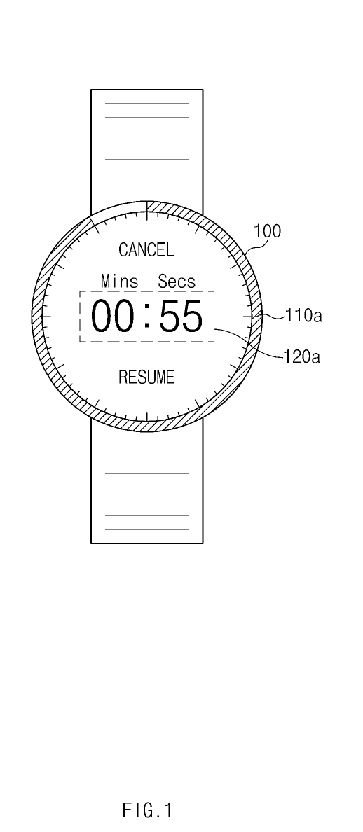

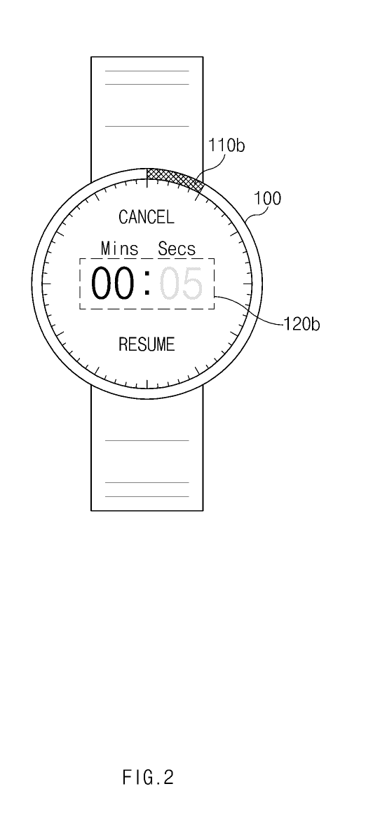

FIG. 1 illustrates an operation of an electronic device, according to an embodiment of the present disclosure. FIG. 2 illustrates another operation of an electronic device, according to an embodiment of the present disclosure.

Referring to FIG. 1, an electronic device 100 according to an embodiment may be a smart watch. The electronic device 100 may provide a timer function. In the case where the electronic device 100 provides the timer function, the electronic device 100 may display a user interface for using the timer.

The user interface outputted through the display of the electronic device 100 may include a gauge display area 110a and a remaining time display area 120a that display the remaining time from a current time to a set notification time. The remaining time display area 120a may display the remaining time in unit of minutes or seconds. The gauge display area 110a may display a gauge corresponding to the remaining time. As the remaining time decreases, the gauge length of the gauge display area 110a may be reduced according to the decreasing remaining time.

Referring to FIG. 2, after a specific time elapses, the electronic device 100 according to an embodiment may display the elapsed time on the user interface of the electronic device 100. The user interface outputted through the display of the electronic device 100 may include a gauge display area 110b and a remaining time display area 120b.

In the case where the remaining time from the current time to the set notification time is smaller than or equal to a designated range (e.g., in the case where the current time less than 5 seconds from the set notification time), the gauge color of the gauge display area 110b may be changed. For example, in the case where the gauge color of the gauge display area 110a of FIG. 1 is displayed with a blue color, the gauge color of the gauge display area 110b of FIG. 2 may be displayed with a red color.

Moreover, in the case where the remaining time from the current time to the set notification time is smaller than or equal to a designated range (e.g., in the case where the current time is less than 5 seconds from the set notification time), the text color of the remaining time display area 120b may be changed. For example, in the case where the text color of the remaining time display area 120a of FIG. 1 is displayed with a white color, the text color of the time display area 120b of FIG. 2 may be displayed with a yellow color.

According to an embodiment, in the case where the remaining time from the current time to the set notification time is smaller than or equal to a designated range, the electronic device 100 may provide notifications of various types, such as a vibration notification, a sound notification, and the like. For example, in the case where the current time is less than 5 seconds from the set notification time, the electronic device 100 may provide a vibration notification or sound notification in unit of second. As another example, in the case where the current time is less than 5 seconds from the set notification time, the electronic device 100 may provide a vibration notification or sound notification of which the intensity gradually increases.

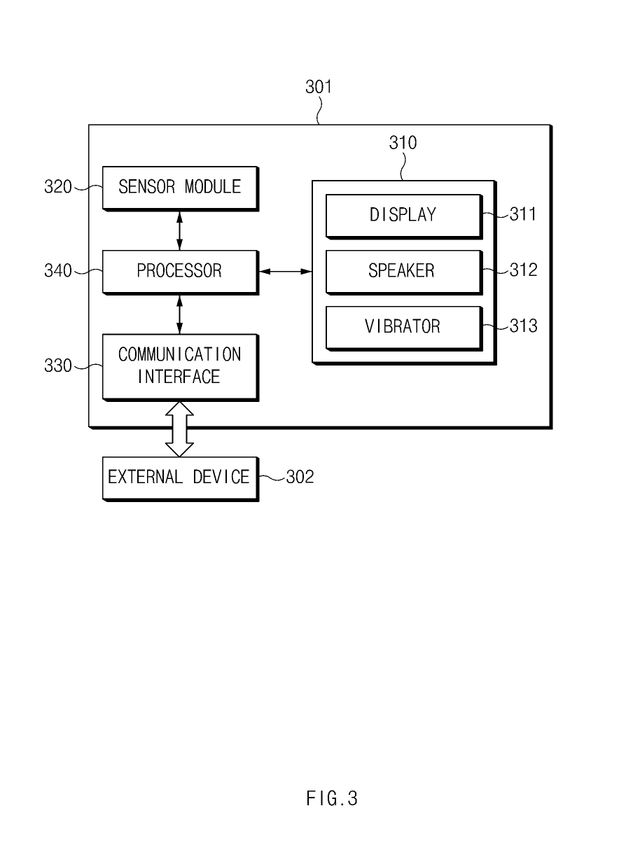

FIG. 3 is a block diagram illustrating a configuration of an electronic device, according to an embodiment of the present disclosure.

Referring to FIG. 3, an electronic device 301 may include an output module 310, a sensor module 320, a communication interface 330, and a processor 340. The output module 310 may include a display 311, a speaker 312, or a vibrator 313. The electronic device 301 may communicate with an external device 302 using the communication interface 330.

The electronic device 301 may provide a notification associated with certain information based on a relation between a current value of the information and a target value associated with the information. The information may include a variety of information, for example, time information, location information, distance information, height information, depth information, pressure information, ultra violet (UV) intensity information, fine dust concentration information, temperature information, heartbeat information, remaining capacity information, and the like. Embodiments for notifications of the various type of information will be explained in detail below.

In the present disclosure, a current value may be a value that indicates a current state associated with the information. For example, in the case where the information is time information, the current value may be a current time of the electronic device 301. In the case where the information is location information, the current value may be the current location of the electronic device 301. According to an embodiment, the current value may be a value stored in the electronic device 301 and may be obtained from the sensor module 320 or received from the external device 302.

In the present disclosure, the target value may be a value to be compared with the current value. The target value may be a value that is set such that the notification is provided according to a difference between the current value and the target value. For example, in the case where the information associated with the notification is time information, the target value may be the time that is set such that the notification is provided at the target time. In the case where the information is location information, the target value may be a location that is set such that a notification is provided at the target location. According to an embodiment, the target value may be a value set by a user and/or may be a value that is previously stored in the electronic device 301. The target value may include two or more values.

The output module 310 may output a notification associated with the information such as time information. The output module 310 may provide various notifications that a user is capable of recognizing. According to an embodiment, the output module 310 may include the display 311, the speaker 312, or the vibrator 313 for visual, auditory, and tactile notifications. The notification output by the output module 310 may be changed according to a difference between the current value and the target value.

According to an embodiment, the display 311 may output a notification screen associated with the information. For example, in the case where the information associated with the notification is heartbeat information, the display 311 may output a notification screen including information about the current heart rate and the target heart rate. The brightness, contrast, or hue of the notification screen output through the display 311 may be adjusted based on the difference between the current value and the target value.

According to an embodiment, the speaker 312 may output a sound notification associated with the information. For example, in the case where the information associated with the notification is UV intensity information in an environment surrounding the electronic device 301, the speaker 312 may output a sound notification if the intensity of current UV is within a designated range with respect to the intensity of target UV. The intensity, duration time, period, or frequency of the sound notification output through the speaker 312 may be changed based on the difference between the current value and the target value.

According to an embodiment, the vibrator 313 may output a vibration notification associated with the information. For example, in the case where the information associated with the notification is height information, the vibrator 313 may output a vibration notification if a current height is within a designated range with respect to a target height. The intensity, duration time, period, or frequency of the vibration notification output through the vibrator 313 may be changed based on the difference between the current value and the target value.

The sensor module 320 may sense the current of the information associated with the notification. For example, in the case where the information associated with the notification is temperature information, the sensor module 320 may sense a current temperature. The sensor module 320 may include one or more sensors that are capable of sensing a variety of information, for example, height information, depth information, pressure information, UV intensity information, temperature information, or heartbeat information. For example, the sensor module 320 may include one or more of a variety of sensors such as a gyro sensor, a barometric sensor, a pressure sensor, a UV sensor, a temperature sensor, a heartbeat sensor, and the like.

The communication interface 330 may communicate with the external device 302. The communication interface 330 may send data to the external device 302 and may receive data from the external device 302. The communication interface 330 may obtain the current value of the information associated with the notification from the external device 302. For example, in the case where the information designated is fine dust concentration information, the communication interface 330 may receive information about current fine dust concentration from the external device 302 that is a weather service server capable of providing weather information. The communication interface 330 may be connected with the external device 302 through a wired or wireless network.

The processor 340 may control the output module 310, the sensor module 320, and the communication interface 330. The processor 340 may provide a notification associated with the information by using at least one of the display 311, the speaker 312 or the vibrator 313.

The processor 340 may obtain the current value of the information associated with the notification. To obtain the current value, the processor 340 may use information stored in the electronic device 301, such as information measured by the electronic device 301, information obtained from the external device 302, or the like. According to an embodiment, the processor 340 may obtain the current value from the information stored in the electronic device 301. According to an embodiment, the processor 340 may calculate the current value. According to an embodiment, the processor 340 may obtain the current value from the sensor module 320. According to an embodiment, the processor 340 may obtain the current value from the external device 302.

The processor 340 may compare the current value with the target value. For example, the processor 340 may compare the magnitude of the current value with the magnitude of the target value. According to an embodiment, the processor 340 may determine whether the current value is within a designated range with respect to the target value by comparing the current value with the target value. According to an embodiment, the processor 340 may compare the current value with the target value and may determine whether the current value is equal to a designated range. According to an embodiment, the processor 340 may calculate a difference between the current value and the target value.

In the case where the current value is within a designated range with respect to the target value, the processor 340 may provide a notification of a first type. In the case where the current value approaches the target value (e.g., in the case where the current time is within 5 seconds from the target time), the processor 340 may provide the notification of the first type. According to an embodiment, in the case where the current value is within a designated range with respect to the target value, the processor 340 may repeatedly provide the notification of the first type at regular intervals.

According to an embodiment, the processor 340 may change the notification of the first type based on the difference between the current value and the target value. For example, the processor 340 may adjust at least one or more of the brightness, contrast, or hue of the notification screen outputted through the display 311 based on the difference between the current value and the target value. As another example, the processor 340 may change at least one or more of the intensity, duration time, period, or frequency of a sound notification outputted through the speaker 312 based on the difference between the current value and the target value. As another example, the processor 340 may change at least one or more of the intensity, duration time, period, or frequency of a vibration notification outputted through the vibrator 313 based on the difference between the current value and the target value. The processor 340 may provide the notification of the first type through two or more modules of the display 311, the speaker 312, or the vibrator 313.

According to an embodiment, in the case where the current value is equal to the target value, the processor 340 may provide a notification of a second type that is different from the first type. In the case where the current value reaches the target value (i.e. the current value equals the target value), the processor 340 may provide the notification of the second type through the display 311, the speaker 312, or the vibrator 313. The notification of the second type may be different from the notification of the first type in one or more of characteristics such as brightness, contrast, hue, intensity, a duration time, a period, or a frequency. The processor 340 may provide the notification of the second type through two or more modules of the display 311, the speaker 312, or the vibrator 313.

The external device 302 may communicate with the electronic device 301 through the communication interface 330. The external device 302 may provide the electronic device 301 with the current value corresponding to a variety of information that the electronic device 301 is not capable of directly obtaining. For example, the external device 302 may provide information about fine dust concentration to the electronic device 301. The external device 302 may be connected with the electronic device 301 through a wired or wireless network.

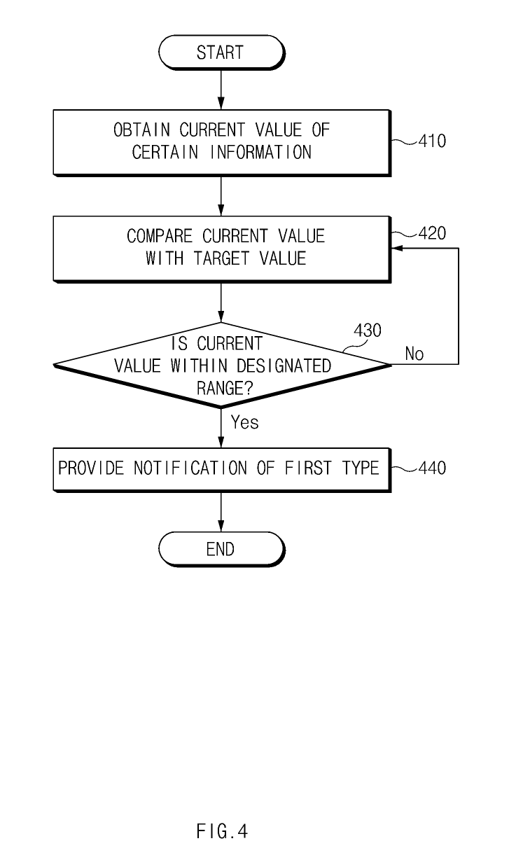

FIG. 4 is a flowchart illustrating a notification providing method of an electronic device according to an embodiment of the present disclosure.

The flowchart illustrated in FIG. 4 may include operations that the electronic device 301 illustrated in FIG. 3 processes. Even though omitted below, the above description about the electronic device 301 described with reference to FIG. 3 may be applied to the flowchart illustrated in FIG. 4.

Referring to FIG. 4, in operation 410, the electronic device 301 may obtain a current value of certain information. The electronic device 301 may obtain the current value of the information through a variety of way as described above. The information may be set by the user, for example, the user may set notifications for time information.

According to an embodiment, in the case where the information associated with the notification is time information, the electronic device 301 may obtain a current time by using a timepiece application, a clock generator, or the like. Alternatively, the electronic device 301 may obtain the current time externally (e.g., a time synchronization server). The electronic device 301 may store the obtained current value in a memory.

As another example, in the case where the information associated with the notification is heart rate information, the electronic device 301 may obtain a current heart rate by using a heartbeat sensor. As another example, in the case where the information designated is location information, the electronic device 301 may obtain a current location by calculating the current location based on a signal received from a global positioning system (GPS) satellite.

In operation 420, the electronic device 301 may compare the obtained current value with a target value. The target value may be a value set by a user or may be a value that is previously set by the electronic device 301. The electronic device 301 may compare the current value with the target value.

According to an embodiment, in the case where the information designated is time information, the electronic device 301 may compare the current time with a target time. Until the current time reaches the target time, the electronic device 301 may continuously compare the current time with the target time. Operations 430 and 440 may be performed based on the compared result in operation 420.

As another example, in the case where the information designated is heart rate information, the electronic device 301 may compare a current heart rate with a target heart rate. As another example, in the case where the information designated is location information, the electronic device 301 may compare a current location with a target location.

In operation 430, the electronic device 301 may determine whether the current value is within a designated (i.e. predetermined) range with respect to the target value, based on the compared result.

According to an embodiment, in the case where the information designated is time information, the electronic device 301 may determine whether the current time is within the designated range with respect to the target time, based on the result obtained by comparing the current time and the target time. For example, the electronic device 301 may determine whether the current time is within 10 seconds from the target time. The user may change the designated range. Before the current time reaches the target time, the electronic device 301 may continuously determine whether the current time is within the designated range with respect to the target time.

As another example, in the case where the information designated is heartbeat information, the electronic device 301 may determine whether a current heart rate is within 20 bpm from a target heart rate. As another example, in the case where the information designated is location information, the electronic device 301 may determine whether a current location is within 15 m from a target location. The designated range may be arbitrarily changed by a user.

In operation 440, in the case where the current value is within the designated range with respect to the target value, the electronic device 301 may provide a notification of a first type. In the case where the current value is within the designated range with respect to the target value, the electronic device 301 may provide the notification of the first type such that a user recognizes that the current value is approaching the target value. In addition, in the case where the current value approaches the target value within a designated range, the electronic device 301 may provide the notification of the first type at regular intervals.

According to an embodiment, to notify a user that the current time approaches the target time, the electronic device 301 may consistently provide a notification. For example, in the case where the current time is within 10 seconds from the target time, the electronic device 301 may provide the notification of the first type every second.

As another example, in the case where a current heart rate is within 20 bpm from a target heart rate, the electronic device 301 may provide the notification of the first type whenever the current heart rate approaches the target heart rate by another 1 bpm. As another example, in the case where a current location is within 15 m from a target location, the electronic device 301 may provide the notification of the first type every two seconds.

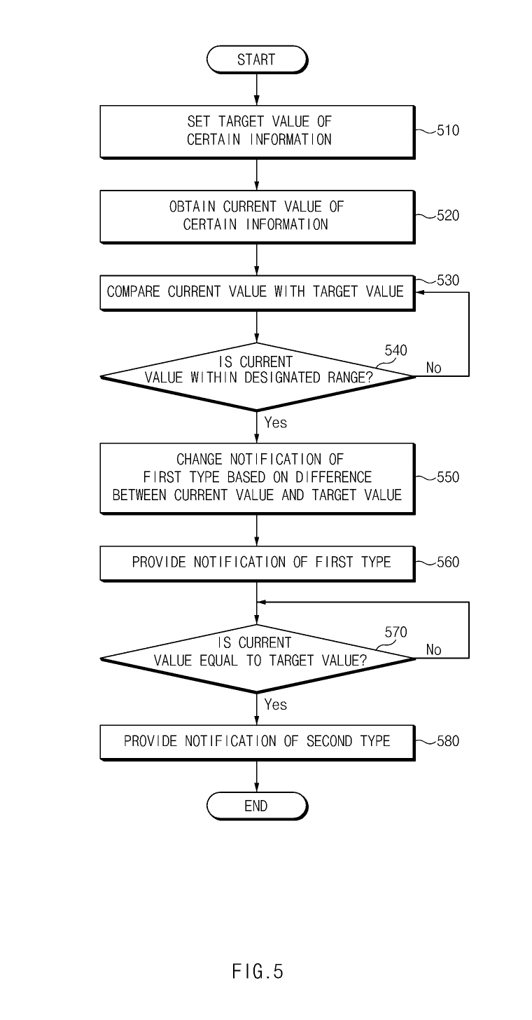

FIG. 5 is a flowchart illustrating a notification providing method of an electronic device according to another embodiment of the present disclosure.

The flowchart illustrated in FIG. 5 may include operations that the electronic device 301 illustrated in FIG. 3 processes. Even though omitted below, the above description about the electronic device 301 described with reference to FIG. 3 may be applied to the flowchart illustrated in FIG. 5.

For descriptive convenience, a detailed description about operations described with reference to FIG. 4 will not be repeated here.

Referring to FIG. 5, in operation 510, the electronic device 301 may set a target value of certain information associated with a notification, such as time information.

According to an embodiment, the electronic device 301 may set the target value of the information by receiving the target value from a user through a user interface. For example, in the case where the information associated with the notification is time information, the electronic device 301 may set the target time by receiving the target time from a user through a user interface.

According to an embodiment, the electronic device 301 may set a value, which is previously stored in the electronic device 301, as the target value. For example, in the case where the information associated with the notification is heartbeat information, the electronic device 301 may set as the target values the minimum and maximum beats per minute of a normal and healthy heartbeat range. Information regarding healthy heartbeat ranges may be stored in the electronic device 301.

According to an embodiment, the electronic device 301 may set the target value according to a value received from the external device 302. For example, in the case where the information associated with the notification is location information, the electronic device 301 may receive a coordinate value corresponding to a target location from the external device 302, which provides a map service. The electronic device 301 may then set the target location based on the received coordinate value.

In operation 520, the electronic device 301 may obtain a current value of the information associated with the notification.

In operation 530, the electronic device 301 may compare the obtained current value with the set target value.

In operation 540, the electronic device 301 may determine whether the current value is within a designated range with respect to the target value, based on the compared result.

In operation 550, the electronic device 301 may change a notification of the first type based on a difference between the current value and the target value. The electronic device 301 may change the characteristic of the notification of the first type such that a user recognizes, for example, that the current values is approaching the target value.

According to an embodiment, the electronic device 301 may calculate the difference between the current value and the target value based on the result obtained by comparing the current value and the target value. For example, in the case where the information associated with the notification is time information, the electronic device 301 may calculate a difference between a target time and a current time. As another example, in the case where the information associated with the notification is heartbeat information, the electronic device 301 may calculate a heart rate difference between a current heart rate and a target heart rate. As another example, in the case where the information associated with the notification is location information, the electronic device 301 may calculate a distance between a current location and a target location.

According to an embodiment, the electronic device 301 may adjust the brightness, contrast, or hue of a notification screen outputted through the display 311 based on a difference between the current value and the target value. For example, the electronic device 301 may determine a notification screen such that the brightness of a notification screen gradually brightens as a current time approaches a target time. As another example, the electronic device 301 may determine a notification screen such that the color of the notification screen is changed when the current time is within a designated range with respect to the target time.

According to an embodiment, the electronic device 301 may change the intensity, duration time, period, or frequency of a sound notification outputted through the speaker 312 based on the difference between the current value and the target value. For example, the electronic device 301 may determine a sound notification such that the intensity of the sound notification gradually increases as the current heart rate approaches the target heart rate. As another example, the electronic device 301 may determine a sound notification such that the period of the sound notification gradually decreases as the current heart rate approaches the target heart rate.

According to an embodiment, the electronic device 301 may change the intensity, duration time, period, or frequency of a vibration notification outputted through the vibrator 313 based on the difference between the current value and the target value. For example, as the current location approaches the target location, the electronic device 301 may determine a vibration notification such that the duration time of the vibration notification gradually increases. As another example, the electronic device 301 may determine a vibration notification such that the frequency of the vibration notification gradually increases as the current location approaches the target location.

In operation 560, in the case where the current value is within a designated range with respect to the target value, the electronic device 301 may provide the changed notification of the first type. The electronic device 301 may provide the notification of the first type changed based on the difference between the current value and the target value such that a user recognizes that, for example, the current value is approaching the target value.

In operation 570, the electronic device 301 may determine whether the current value is equal to the target value based on the result obtained by comparing the current value with the target value.

According to an embodiment, in the case where the information associated with the notification is time information, the electronic device 301 may determine whether the current time reaches the target time (i.e. the current time is the same as the target time), based on the result obtained by comparing the current value with the target value.

As another example, if the information associated with the notification is heartbeat information, the electronic device 301 may determine whether the current heart rate reaches the target heart rate. As another example, if the information associated with the notification is location information, the electronic device 301 may determine whether a current location reaches a target location.

In operation 580, in the case where the current value is equal to the target value, the electronic device 301 may provide a notification of a second type. The electronic device 301 may provide the notification of the second type, which is different from the first type, such that a user distinguishes the notification of the second type from the notification of the first type. Compared with the notification of the first type, the notification of the second type may include a notification according to another scheme or may include a notification of which the intensity is relatively high. For example, the notification of the first type may include only a notification through a visual display, but the notification of the second type may further include a notification of a sound or vibration scheme in addition to a display notification. Alternatively, the notification of the first type may be provided as a notification of which the intensity is 5, but the notification of the second type may be provided as a notification of which the intensity is 10.

According to an embodiment, in the case where the current time reaches the target time, the electronic device 301 may provide the notification of the second type. In the case where the electronic device 301 provides a vibration notification as a notification of the first type, the electronic device 301 may provide a sound notification as a notification of the second type. The electronic device 301 may provide the notification of the second type of which the duration time is longer than that of the notification of the first type.

As another example, in the case where the current heart rate reaches the target heart rate, the electronic device 301 may provide the notification of the second type. As another example, in the case where the current location reaches the target location, the electronic device 301 may provide the notification of the second type.

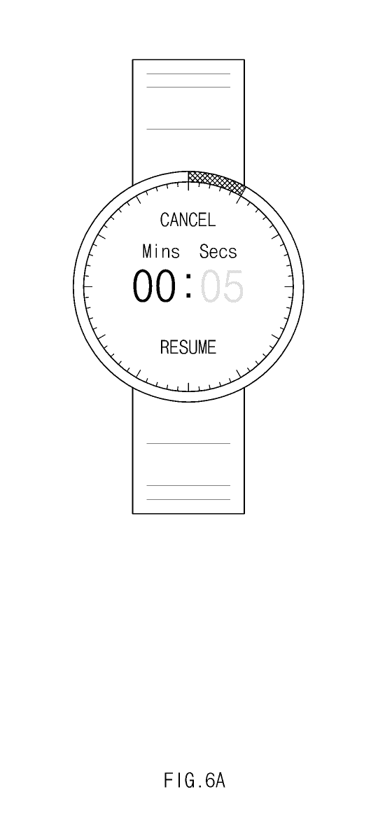

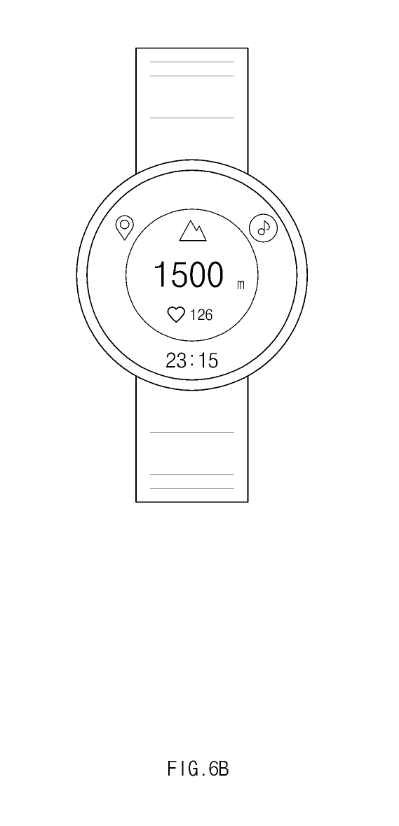

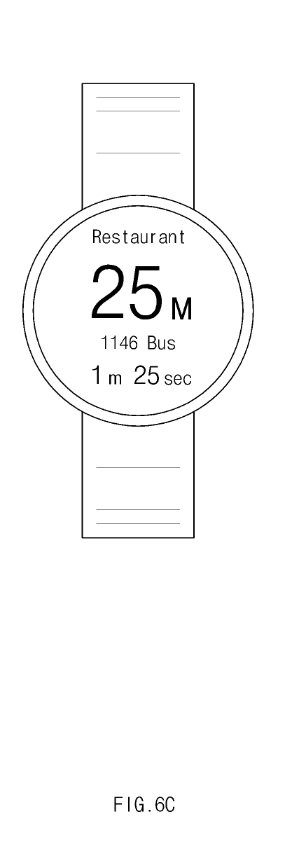

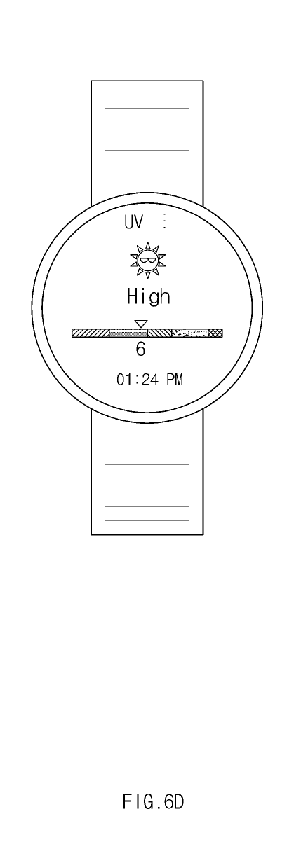

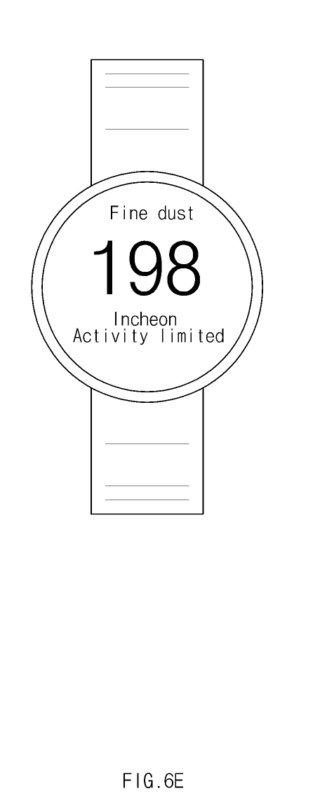

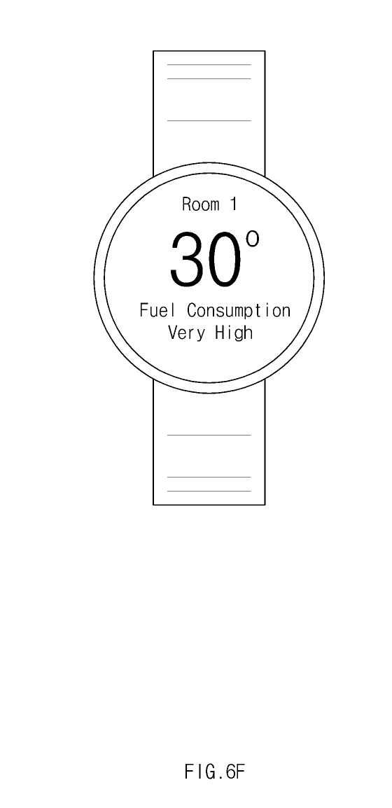

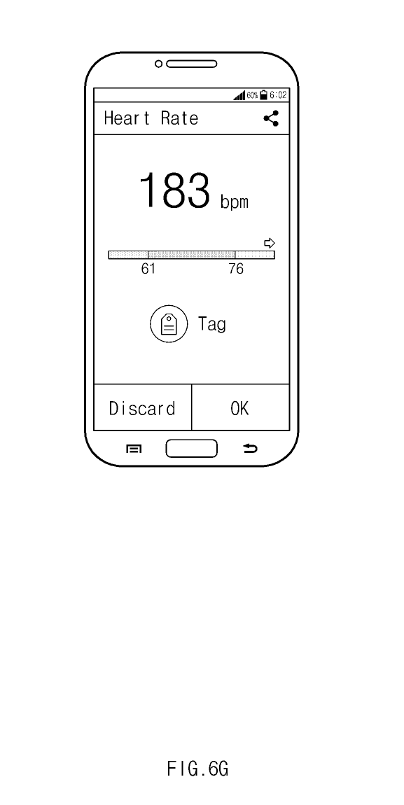

FIGS. 6A to 6G illustrate configurations of exemplary screens provided by an electronic device, according to various embodiments of the present disclosure.

As illustrated in FIGS. 6A to 6Q an electronic device may provide a user with notifications associated with a variety of information, for example, time information, height information, location information, distance information, UV intensity information, fine dust concentration information, temperature information, remaining capacity information, heartbeat information, and the like.

Referring to FIG. 6A, the electronic device may provide a user interface associated with a timer function. As illustrated in FIG. 6A, an electronic device according to an embodiment of the present disclosure may be a wearable device such as a smart watch. The electronic device may display the remaining time to a time when a notification is set with a text, a gauge, and the like. Here, a designated range may be 5 seconds when the notification of the first type is provided. In the case where the remaining time is smaller than or equal to 5 seconds, the electronic device may change the color of the text and the gauge for displaying the remaining time. Although not illustrated in FIG. 6A, in the case where the remaining time is smaller than or equal to 5 seconds, the electronic device may provide a sound notification or vibration notification in unit of second. The electronic device may provide a sound notification or vibration notification such that the intensity of a notification gradually increases as the remaining time decreases. Finally, when the current time reaches the set time, a notification of a second type may be provided by the electronic device.

Referring to FIG. 6B, the electronic device may provide a user interface associated with a climbing guide function. The electronic device may display a current height, a current heart rate, a current time, or the like. Here, the target height may be 1600 m, and a designated range may be 100 m such that a notification of a first type is provided. In the case where the current height reaches 1500 m, the electronic device may change the color of a text for displaying the current height. Although not illustrated in FIG. 6B, in the case where the current height reaches 1500 m, the electronic device may provide a sound notification or vibration notification whenever the current height increases by 10 m. The electronic device may provide a sound notification or vibration notification such that the duration time of the notification gradually increases as a current height approaches a target height. When the current height reaches the set height, a notification of a second type may be provided by the electronic device.

Referring to FIG. 6C, the electronic device may provide a user interface associated with a location guide function. The electronic device may display a distance between a current location and a target location, transportation for moving to the target location, and expected time of arrival with respect to the target location, and the like. Here, a designated range may be 25 m such that the notification of the first type is provided. In the case where a distance between the current location and the target location is smaller than or equal to 25 m, the electronic device may change the brightness of a text for displaying the distance between the current location and the target location. Although not illustrated in FIG. 6C, in the case where the distance between the current location and the target location is smaller than or equal to 25 m, the electronic device may provide a sound notification or vibration notification. The electronic device may provide a sound notification or vibration notification such that the intensity of the notification gradually increases whenever the distance between the current location and the target location is reduced by 1 m. When the current location reaches the target location, a notification of a second type may be provided by the electronic device.

Referring to FIG. 6D, the electronic device may provide a user interface associated with a UV check function. The electronic device may display a text indicating UV intensity, a graph with respect to the UV intensity, an UV index, or the like. Here, the target UV index may be 10, and a designated range may be 4 such that a notification of a first type is provided. In the case where the UV index is greater than or equal to 6, the electronic device may output a text “High” to indicate the UV intensity. Although not illustrated in FIG. 6D, in the case where a difference between a current UV index and a target UV index is smaller than or equal to 4, the electronic device may provide a sound notification or vibration notification. The electronic device may provide a sound notification or vibration notification such that the period of the notification gradually decreases whenever a current UV index increases by 1. When the current UV intensity equals the target UV intensity, a notification of a second type may be provided by the electronic device.

Referring to FIG. 6E, the electronic device may provide a user interface associated with a fine dust alert function. The electronic device may display the concentration and the area of a current fine dust, action guidelines according to the concentration of a fine dust, and the like. Here, the concentration of a target fine dust may be 200 μg/m³, and a designated range may be 50 μg/m³ such that a notification of a first type is provided. In the case where the concentration of a current fine dust is greater than or equal to 150 μg/m³, the electronic device may display a text “Activity limited” to display action guidelines with respect to the concentration of a fine dust. Although not illustrated in FIG. 6E, in the case where the concentration of the current fine dust is greater than or equal to 150 μg/m³, the electronic device may provide a sound notification or vibration notification. The electronic device may provide a sound notification or vibration notification such that the frequency of a notification gradually increases whenever the concentration of the current fine dust increases by 5 μg/m³. When the current fine dust concentration equals the target fine dust concentration, a notification of a second type may be provided by the electronic device.

Referring to FIG. 6F, the electronic device may provide a user interface associated with a thermometer function. The electronic device may display a place in which a temperature is measured, a current temperature, fuel consumption used for temperature control, and the like. Here, the target temperature may be 35° C., a designated range may be 5° C. such that a notification of a first type is provided. In the case where the current temperature is greater than or equal to 30° C., the electronic device may display a text “Very High” to display the fuel consumption used for heating. Although not illustrated in FIG. 6F, in the case where the current temperature is greater than or equal to 30° C., the electronic device may provide a sound notification or vibration notification. The electronic device may provide a sound notification or vibration notification such that the intensity of a notification gradually increases whenever the current temperature increases by 1° C. When the current temperature equals the target temperature, a notification of a second type may be provided by the electronic device.

Referring to FIG. 6G, the electronic device may provide a user interface associated with a heart rate measurement function. As illustrated in FIG. 6G, the electronic device according to an embodiment of the present disclosure may be a device such as a smartphone, a tablet PC, or the like. The electronic device may display a current heart rate and a graph with respect to a range of a normal heart rate. Here, the target heart rate may be 200 bpm, and a designated range may be 20 bpm such that a notification of a first type is provided. In the case where the current heart rate is greater than or equal to 180 bpm, the electronic device may change the color of a text indicating the current heart rate. Although not illustrated in FIG. 6G in the case where the current heart rate is greater than or equal to 180 bpm, the electronic device may provide a sound notification or vibration notification. The electronic device may provide a sound notification or vibration notification such that the duration time of a notification gradually increases whenever a current heart rate increases by 5 bpm. When the current heart rate matches the target heart rate, a notification of a second type may be provided by the electronic device.

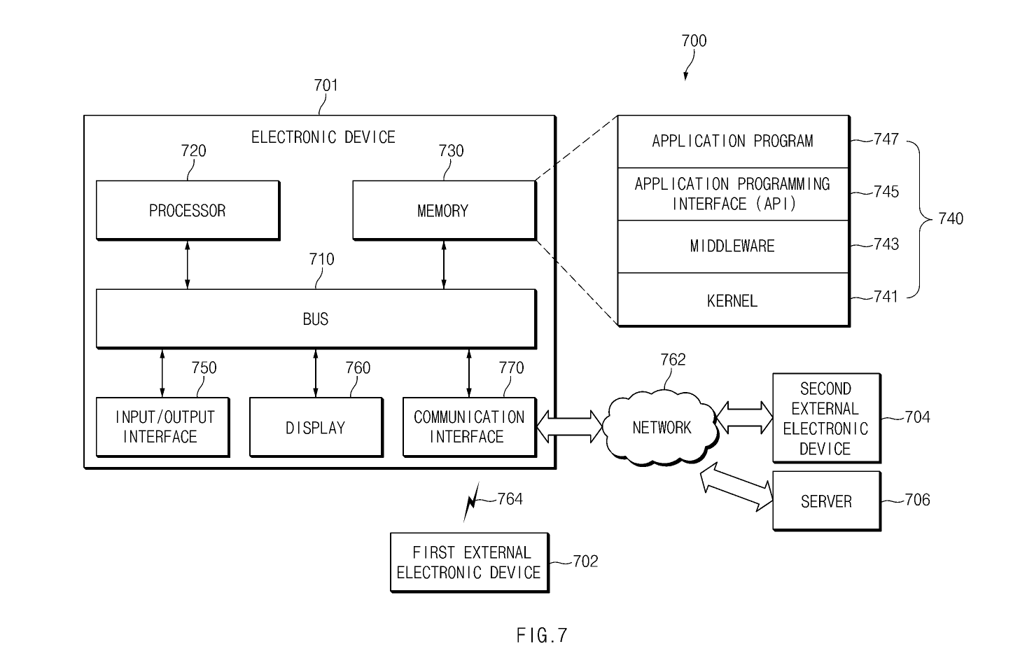

FIG. 7 illustrates an electronic device in a network environment, according to various embodiments of the present disclosure.

Referring to FIG. 7, according to various embodiments, an electronic device 701, 702, or 704 or a server 706 may be connected with each other through a network 762 or a local area network 764. The electronic device 701 may include a bus 710, a processor 720, a memory 730, an input/output interface 750, a display 760, and a communication interface 770. According to an embodiment, the electronic device 701 may not include at least one of the above-described elements or may further include other element(s).

For example, the bus 710 may interconnect the above-described elements 720 to 770 and may be a circuit for conveying communications (e.g., a control message and/or data) among the above-described elements.

The processor 720 may include one or more of a central processing unit (CPU), an application processor (AP), or a communication processor (CP). For example, the processor 720 may perform an arithmetic operation or data processing associated with control and/or communication of at least other elements of the electronic device 701.

The memory 730 may include a volatile and/or nonvolatile memory. The memory 730 may store instructions or data associated with at least one other element(s) of the electronic device 701. According to an embodiment, the memory 730 may store software and/or a program 740. The program 740 may include, for example, a kernel 741, a middleware 743, an application programming interface (API) 745, and/or an application program (or an application) 747. At least a part of the kernel 741, the middleware 743, or the API 745 may be called an “operating system (OS)”.

The kernel 741 may control or manage system resources (e.g., the bus 710, the processor 720, the memory 730, and/or other hardware and software resources) that are used to execute operations or functions of other programs (e.g., the middleware 743, the API 745, and the application program 747). Furthermore, the kernel 741 may provide an interface that allows the middleware 743, the API 745, or the application program 747 to access discrete elements of the electronic device 701 so as to control or manage system resources.

The middleware 743 may perform a mediation role such that the API 745 or the application program 747 communicates with the kernel 741 to exchange data.

Furthermore, the middleware 743 may process task requests received from the application program 747 according to a priority. For example, the middleware 743 may assign the priority, which makes it possible to use a system resource (e.g., the bus 710, the processor 720, the memory 730, or the like) of the electronic device 701, to at least one of the application program 747. For example, the middleware 743 may process the one or more task requests according to the priority assigned to the at least one, which makes it possible to perform scheduling or load balancing on the one or more task requests.

The API 745 may be an interface through which the application program 747 controls a function provided by the kernel 741 or the middleware 743, and may include, for example, at least one interface or function (e.g., an instruction) for a file control, a window control, image processing, a character control, or the like.

The I/O interface 750 may transmit an instruction or data, input from a user or another external device, to other element(s) of the electronic device 701. Furthermore, the input/output interface 750 may output an instruction or data, received from other element(s) of the electronic device 701, to a user or another external device.

The display 760 may include, for example, a liquid crystal display (LCD), a light-emitting diode (LED) display, an organic LED (OLED) display, a microelectromechanical systems (MEMS) display, or an electronic paper display. The display 760 may display, for example, various contents (e.g., a text, an image, a video, an icon, a symbol, and the like) to a user. The display 760 may include a touch screen and may receive, for example, a touch, gesture, proximity, or hovering input using an electronic pen or a part of a user's body using capacitive, resistive, or another type of technology.

The communication interface 770 may establish communication between the electronic device 701 and an external device (e.g., a first external electronic device 702, a second external electronic device 704, or a server 706). For example, the communication interface 770 may be connected to a network 762 through wireless communication or wired communication to communicate with the external device (e.g., the second external electronic device 704 or the server 706).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Furthermore, the wireless communication may include, for example, a local area network 764. The local area network 764 may include at least one of a wireless fidelity (Wi-Fi), a Bluetooth, a near field communication (NFC), a magnetic secure transmission (MST), a global navigation satellite system (GNSS), or the like.

The MST may generate a pulse in response to transmission data by using an electromagnetic signal, and the pulse may generate a magnetic field signal. The electronic device 701 may send the magnetic field signal to point of sale (POS). The POS may detect the magnetic field signal using a MST reader and may recover the data by converting the detected magnetic field signal to an electrical signal.

The GNSS may include at least one of a global positioning system (GPS), a global navigation satellite system (Glonass), a Beidou Navigation Satellite System (hereinafter referred to as “Beidou”), or a European global satellite-based navigation system (Galileo). Hereinafter, “GPS” and “GNSS” may be used interchangeably in this disclosure. The wired communication may include at least one of, for example, a universal serial bus (USB), a high definition multimedia interface (HDMI), a recommended standard 232 (RS-232), a plain old telephone service (POTS), or the like. The network 762 may include at least one of telecommunications networks, for example, a computer network (e.g., LAN or WAN), an Internet, or a telephone network.

Each of the first and second external electronic devices 702 and 704 may be a device of which the type is different from or the same as that of the electronic device 701. According to an embodiment, the server 706 may include a group of one or more servers. According to one embodiment, all or a part of operations that the electronic device 701 will perform may be executed by another or plural electronic devices (e.g., the external electronic devices 702 and 704 or the server 706). According to an embodiment, in the case where the electronic device 701 executes any function or service automatically or in response to a request, the electronic device 701 may not perform the function or the service internally, but, alternatively additionally, it may request at least a part of a function associated with the electronic device 201 at other device (e.g., the external electronic device 702 or 704 or the server 706). The other electronic device (e.g., the external electronic device 702 or 704 or the server 706) may execute the requested function or additional function and may transmit the execution result to the electronic device 701. The electronic device 701 may provide the requested function or service using the received result or may additionally process the received result to provide the requested function or service. To this end, for example, cloud computing, distributed computing, or client-server computing may be used.

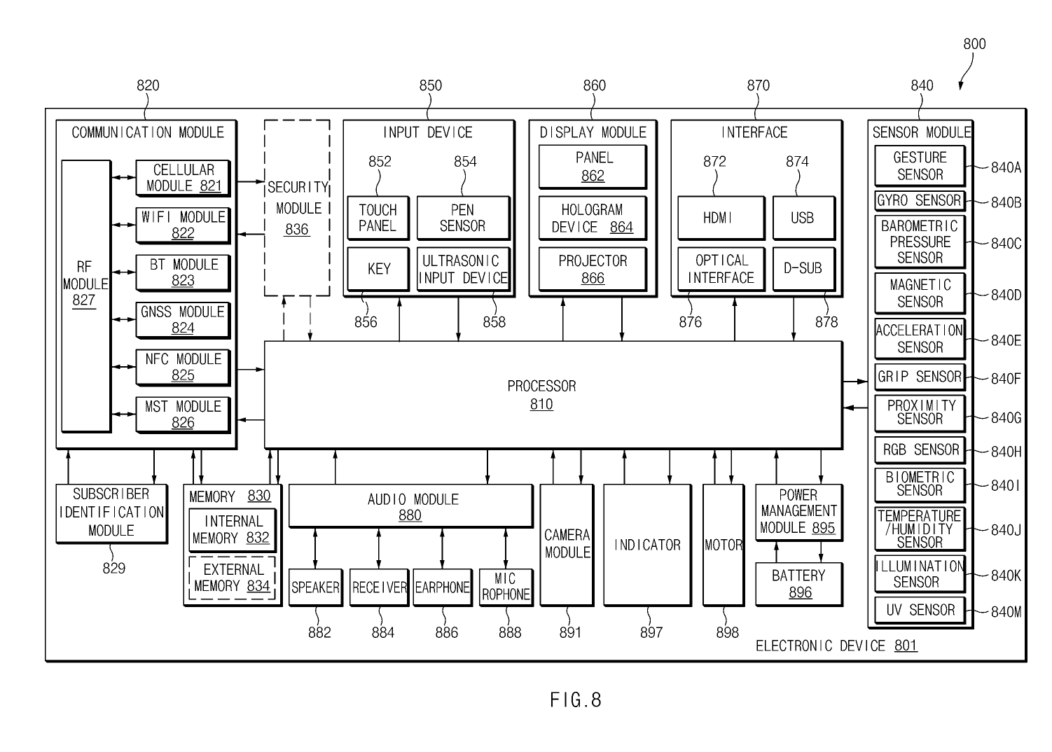

FIG. 8 illustrates a block diagram 800 of an electronic device 801 according to various embodiments of the present disclosure.

Referring to FIG. 8, the electronic device 801 may include, for example, all or a part of the electronic device 701 illustrated in FIG. 7. The electronic device 801 may include one or more processors (e.g., an application processor) 810, a communication module 820, a subscriber identification module 829, a memory 830, a sensor module 840, an input device 850, a display 860, an interface 870, an audio module 880, a camera module 891, a power management module 895, a battery 896, an indicator 897, and a motor 898.

The processor 810 may drive an operating system (OS) or an application to control a plurality of hardware or software elements connected to the processor 810 and may process and compute a variety of data. For example, the processor 810 may be implemented with a System on Chip (SoC). According to an embodiment, the processor 810 may further include a graphic processing unit (GPU) and/or an image signal processor. The processor 810 may include at least a part (e.g., a cellular module 821) of elements illustrated in FIG. 8. The processor 810 may load and process an instruction or data, which is received from at least one of other elements (e.g., a nonvolatile memory), and may store a variety of data at a nonvolatile memory. The control unit or processor may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

The communication module 820 may be configured the same as or similar to a communication interface 770 of FIG. 7. The communication module 820 may include a cellular module 821, a Wi-Fi module 822, a Bluetooth (BT) module 823, a GNSS module 824 (e.g., a GPS module, a Glonass module, a Beidou module, or a Galileo module), a near field communication (NFC) module 825, a MST module 826, and a radio frequency (RF) module 827.

The cellular module 821 may provide voice communication, video communication, a character service, an Internet service, or the like through a communication network. According to an embodiment, the cellular module 821 may perform discrimination and authentication of the electronic device 801 within a communication network using the subscriber identification module 829 (e.g., a SIM card). According to an embodiment, the cellular module 821 may perform at least a portion of functions that the processor 810 provides. According to an embodiment, the cellular module 821 may include a communication processor (CP).

Each of the Wi-Fi module 822, the BT module 823, the GNSS module 824, the NFC module 825, or the MST module 826 may include a processor for processing data exchanged through a corresponding module, for example. According to one embodiment of the present disclosure, at least a part (e.g., two or more elements) of the cellular module 821, the Wi-Fi module 822, the BT module 823, the GNSS module 824, the NFC module 825, or the MST module 826 may be included within one Integrated Circuit (IC) or an IC package.

The RF module 827 may transmit and receive, for example, a communication signal (e.g., an RF signal). For example, the RF module 827 may include a transceiver, a power amplifier module (PAM), a frequency filter, a low noise amplifier (LNA), an antenna, or the like. According to another embodiment, at least one of the cellular module 821, the Wi-Fi module 822, the BT module 823, the GNSS module 824, the NFC module 825, or the MST module 826 may transmit and receive an RF signal through a separate RF module.

The subscriber identification module 829 may include, for example, a subscriber identification module and may include unique identify information (e.g., integrated circuit card identifier (ICCID)) or subscriber information (e.g., integrated mobile subscriber identity (IMSI)).

The memory 830 (e.g., the memory 730) may include an internal memory 832 or an external memory 834. For example, the internal memory 832 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 834 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 834 may be operatively and/or physically connected to the electronic device 801 through various interfaces.

The security module 836 may be a module that includes a storage space of which a security level is higher than that of the memory 830 and may be a circuit that guarantees safe data storage and a protected execution environment. The security module 836 may be implemented with a separate circuit and may include a separate processor. For example, the security module 836 may be in a smart chip or a secure digital (SD) card, which is removable, or may include an embedded secure element (eSE) embedded in a fixed chip of the electronic device 801. Furthermore, the security module 836 may operate based on an operating system (OS) that is different from the OS of the electronic device 801. For example, the security module 836 may operate based on java card open platform (JCOP) OS.

The sensor module 840 may measure, for example, a physical quantity or may detect an operation state of the electronic device 801. The sensor module 840 may convert the measured or detected information to an electric signal. For example, the sensor module 840 may include at least one of a gesture sensor 840A, a gyro sensor 840B, a pressure sensor 840C, a magnetic sensor 840D, an acceleration sensor 840E, a grip sensor 840F, a proximity sensor 840Q a color sensor 840H (e.g., a red, green, blue (RGB) sensor), a biometric sensor 840I, a temperature/humidity sensor 840J, an illuminance sensor 840K, or an UV sensor 840M. Although not illustrated, additionally or generally, the sensor module 840 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 840 may further include a control circuit for controlling at least one or more sensors included therein. According to an embodiment, the electronic device 801 may further include a processor which is a part of the processor 810 or independent of the processor 810 and is configured to control the sensor module 840. The processor may control the sensor module 840 while the processor 810 remains at a sleep state.

The input device 850 may include, for example, a touch panel 852, a (digital) pen sensor 854, a key 856, or an ultrasonic input device 858. The touch panel 852 may use at least one of capacitive, resistive, infrared and ultrasonic detecting methods. Also, the touch panel 852 may further include a control circuit. The touch panel 852 may further include a tactile layer to provide a tactile reaction to a user.

The (digital) pen sensor 854 may be, for example, a part of a touch panel or may include an additional sheet for recognition. The key 856 may include, for example, a physical button, an optical key, a keypad, or the like. The ultrasonic input device 858 may detect (or sense) an ultrasonic signal, which is generated from an input device, through a microphone (e.g., a microphone 888) and may check data corresponding to the detected ultrasonic signal.

The display 860 (e.g., a display 760) may include a panel 862, a hologram device 864, or a projector 866. The panel 862 may be configured to be the same as or similar to the display 760 illustrated in FIG. 7. The panel 862 may be implemented, for example, to be flexible, transparent or wearable. The panel 862 and the touch panel 852 may be integrated into a single module. The hologram device 864 may display a stereoscopic image in a space using a light interference phenomenon. The projector 866 may project light onto a screen so as to display an image. The screen may be arranged in the inside or the outside of the electronic device 801. According to an embodiment of the present disclosure, the display 860 may further include a control circuit for controlling the panel 862, the hologram device 864, or the projector 866.

The interface 870 may include, for example, a high-definition multimedia interface (HDMI) 872, a universal serial bus (USB) 874, an optical interface 876, or a D-subminiature (D-sub) 878. The interface 870 may be included, for example, in the communication interface 770 illustrated in FIG. 7. Additionally or generally, the interface 870 may include, for example, a mobile high definition link (MHL) interface, a SD card/multi-media card (MMC) interface, or an infrared data association (IrDA) standard interface.

The audio module 880 may convert a sound and an electric signal in dual directions. At least a part of the audio module 880 may be included, for example, in the input/output interface 750 illustrated in FIG. 7. The audio module 880 may process, for example, sound information that is input or output through a speaker 882, a receiver 884, an earphone 886, or a microphone 888.

The camera module 891 for shooting a still image or a video may include, for example, at least one image sensor (e.g., a front sensor or a rear sensor), a lens (not illustrated), an image signal processor (ISP, not illustrated), or a flash (e.g., an LED or a xenon lamp, not illustrated).

The power management module 895 may manage, for example, power of the electronic device 801. According to an embodiment, a power management integrated circuit (PMIC), a charger IC, or a battery or fuel gauge may be included in the power management module 895. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 896 and a voltage, current or temperature thereof while the battery is charged. The battery 896 may include, for example, a rechargeable battery and/or a solar battery.

The indicator 897 may display a specific state of the electronic device 801 or a part thereof (e.g., the processor 810), such as a booting state, a message state, a charging state, and the like. The motor 898 may convert an electrical signal into a mechanical vibration and may generate the following effects: vibration, haptic, and the like. Although not illustrated, the electronic device 801 may include a processing device (e.g., a GPU) for supporting a mobile TV. The processing device for supporting a mobile TV may process media data according to the standards of digital multimedia broadcasting (DMB), digital video broadcasting (DVB), MediaFlo™, or the like.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

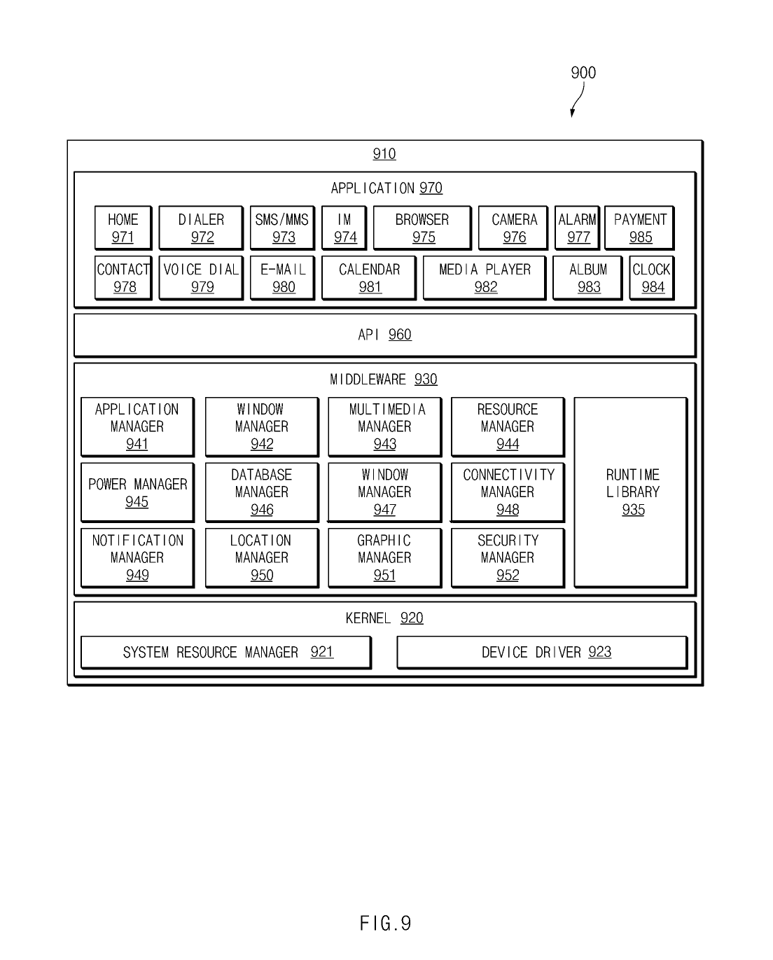

FIG. 9 illustrates a block diagram of a program module, according to various embodiments of the present disclosure.

According to an embodiment, a program module 910 (e.g., the program 740) may include an operating system (OS) to control resources associated with an electronic device (e.g., the electronic device 701), and/or diverse applications (e.g., the application program 747) driven on the OS. The OS may be, for example, android, iOS, windows, symbian, tizen, or bada.

The program module 910 may include a kernel 920, a middleware 930, an application programming interface (API) 960, and/or an application 970. At least a part of the program module 910 may be preloaded on an electronic device or may be downloadable from an external electronic device (e.g., the external electronic device 702 or 704, the server 706, and the like).

The kernel 920 (e.g., the kernel 741) may include, for example, a system resource manager 921, or a device driver 923. The system resource manager 921 may perform control, allocation, or retrieval of system resources. According to an embodiment, the system resource manager 921 may include a process managing unit, a memory managing unit, or a file system managing unit. The device driver 923 may include, for example, a display driver, a camera driver, a Bluetooth driver, a common memory driver, an USB driver, a keypad driver, a Wi-Fi driver, an audio driver, or an inter-process communication (IPC) driver.

The middleware 930 may provide, for example, a function which the application 970 needs in common, or may provide diverse functions to the application 970 through the API 960 to allow the application 970 to efficiently use limited system resources of the electronic device. According to an embodiment, the middleware 930 (e.g., the middleware 743) may include at least one of a runtime library 935, an application manager 941, a window manager 942, a multimedia manager 943, a resource manager 944, a power manager 945, a database manager 946, a package manager 947, a connectivity manager 948, a notification manager 949, a location manager 950, a graphic manager 951, or a security manager 952, or a payment manager 954.

The runtime library 935 may include, for example, a library module which is used by a compiler to add a new function through a programming language while the application 970 is being executed. The runtime library 935 may perform input/output management, memory management, or capacities about arithmetic functions.

The application manager 941 may manage, for example, a life cycle of at least one application of the application 970. The window manager 942 may manage a GUI resource which is used in a screen. The multimedia manager 943 may identify a format necessary for playing diverse media files, and may perform encoding or decoding of media files by using a codec suitable for the format. The resource manager 944 may manage resources such as a storage space, memory, or source code of at least one application of the application 970.

The power manager 945 may operate, for example, with a basic input/output system (BIOS) to manage a battery or power, and may provide power information for an operation of an electronic device. The database manager 946 may generate, search for, or modify database which is to be used in at least one application of the application 970. The package manager 947 may install or update an application that is distributed in the form of package file.

The connectivity manager 948 may manage, for example, wireless connection such as Wi-Fi or Bluetooth. The notification manager 949 may display or notify an event such as arrival message, promise, or proximity notification in a mode that does not disturb a user. The location manager 950 may manage location information of an electronic device. The graphic manager 951 may manage a graphic effect that is provided to a user, or manage a user interface relevant thereto. The security manager 952 may provide a general security function necessary for system security or user authentication. According to an embodiment, in the case where an electronic device (e.g., the electronic device 701) includes a telephony function, the middleware 930 may further includes a telephony manager for managing a voice or video call function of the electronic device.

The middleware 930 may include a middleware module that combines diverse functions of the above-described elements. The middleware 930 may provide a module specialized to each OS kind to provide differentiated functions. Additionally, the middleware 930 may remove a part of the preexisting elements, dynamically, or may add new elements thereto.

The API 960 (e.g., an API 745) may be, for example, a set of programming functions and may be provided with a configuration which is variable depending on an OS. For example, in the case where an OS is the android or the iOS, it may be permissible to provide one API set per platform. In the case where an OS is the tizen, it may be permissible to provide two or more API sets per platform.

The application 970 (e.g., the application program 747) may include, for example, one or more applications capable of providing functions for a home 971, a dialer 972, an SMS/MMS 973, an instant message (IM) 974, a browser 975, a camera 976, an alarm 977, a contact 978, a voice dial 979, an e-mail 980, a calendar 981, a media player 982, an album 983, and a timepiece 984, or for offering health care (e.g., measuring an exercise quantity or blood sugar) or environment information (e.g., atmospheric pressure, humidity, or temperature).

According to an embodiment of the present disclosure, the application 970 may include an application (hereinafter referred to as “information exchanging application” for descriptive convenience) to support information exchange between the electronic device (e.g., the electronic device 701) and an external electronic device (e.g., the external electronic device 702 or 704). The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., the external electronic device 702 or 704). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device (e.g., the external electronic device 702 or 704) which communicates with the electronic device, an application running in the external electronic device, or a service (e.g., a call service or a message service) provided from the external electronic device.

According to an embodiment, the application 970 may include an application (e.g., a health care application) which is assigned in accordance with an attribute (e.g., an attribute of a mobile medical device as a kind of electronic device) of an external electronic device (e.g., the external electronic device 702 or 704). According to an embodiment of the present disclosure, the application 970 may include an application which is received from an external electronic device (e.g., the server 706 or the external electronic device 702 or 704). According to an embodiment, the application 970 may include a preloaded application or a third party application which is downloadable from a server. The titles of elements of the program module 910 according to the embodiment may be modifiable depending on kinds of operating systems.

According to one embodiment, at least a part of the program module 910 may be implemented by software, firmware, hardware, or a combination of two or more thereof. At least a part of the program module 910 may be implemented (e.g., executed), for example, by a processor (e.g., the processor 810). At least a part of the program module 910 may include, for example, modules, programs, routines, sets of instructions, or processes, or the like for performing one or more functions.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to one embodiment of the present disclosure may be, for example, implemented by instructions stored in a computer-readable storage media in the form of a program module. The instruction, when executed by a processor (e.g., the processor 720 of FIG. 10), may cause the one or more processors to perform a function corresponding to the instruction. The computer-readable storage media, for example, may be the memory 730.

According to an embodiment, a computer-readable recording medium may have recorded thereon an instruction, which is executed by at least one processor, causing the processor to perform a method. The method may include obtaining a current value of information, comparing the current value with a target value associated with the information, providing a notification of a first type if the current value is within a range with respect to the target value, and providing a notification of the second type, which is different form the first type, if the current value is equal to the target value.

A computer-readable recording medium may include a hard disk, a magnetic media, a floppy disk, a magnetic media (e.g., a magnetic tape), an optical media (e.g., a compact disc read only memory (CD-ROM) and a digital versatile disc (DVD), a magneto-optical media (e.g., a floptical disk), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

A module or a program module according to one embodiment of the present disclosure may include at least one of the above elements, or a part of the above elements may be omitted, or additional other elements may be further included. Operations performed by a module, a program module, or other elements according to one embodiment of the present disclosure may be executed sequentially, in parallel, repeatedly, or in a heuristic method. In addition, a part of operations may be executed in different sequences or may be omitted. Alternatively, other operations may be added.

According to one embodiment of the present disclosure, in the case where a current value of certain information is within a designated range with respect to a target value, a preliminary notification may be provided to a user, and thus the user may recognize that the current value is approaching the target value. In addition, it is easy for the user to recognize changes in the current value by providing a notification that is capable of being changed based on a difference between the current value and the target value of the designated information. Moreover, a notification indicating the changing current value may be obviously distinguished from a notification indicating that the current value is equal to the target value. This is done by providing a notification of a first type when the current value is within a designated range with respect to the target value and providing a notification of a second type where the current value reaches the target value.

Besides, a variety of effects directly or indirectly understood through the present disclosure may be provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for.”

What is claimed is:

1. An electronic device comprising:
a display;
a speaker;
a vibrator;
a memory for storing information and instructions for execution; and
a processor electrically coupled to the display, the speaker, the vibrator, and the memory, wherein the processor is configured to provide a notification associated with the information stored in the memory by:
obtaining a current value of the information,
comparing the current value with a target value of the information, and
providing a notification of a first type via the display, the speaker or the vibrator when the current value is within a range of the target value and is not equal to the target value.

2. The electronic device of claim 1, wherein the processor is further configured to change the notification of the first type based on a difference between the current value and the target value.

3. The electronic device of claim 2, wherein the processor is further configured to adjust at least one of brightness, contrast, or hue of the notification of the first type based on the difference between the current value and the target value, when the notification of the first type is a notification screen output through the display.

4. The electronic device of claim 2, wherein the processor is further configured to change at least one of intensity, a duration time, a period or a frequency of the notification of the first type based on the difference between the current value and the target value, when the notification of the first type is a sound notification output through the speaker.

5. The electronic device of claim 2, wherein the processor is further configured to change at least one of intensity, a duration time, a period or a frequency of the notification of the first type based on the difference between the current value and the target value, when the notification of the first type is a vibration notification output through the vibrator.

6. The electronic device of claim 1, wherein the processor is further configured to provide a notification of a second type different from the first type when the current value is equal to the target value.

7. The electronic device of claim 1, further comprising:
a sensor module configured to sense the information,
wherein the processor is configured to obtain the current value using the sensor module.

8. The electronic device of claim 1, further comprising:
a communication interface configured to communicate with an external device,
wherein the processor is configured to obtain the current value from the external device using the communication interface.

9. The electronic device of claim 1, wherein the processor is further configured to set a value received from a user or a previously stored value as the target value.

10. The electronic device of claim 1, wherein the information is time information, and the processor is configured to:
obtain a current time,
compare the current time with a target time,
when the current time is within a time range of the target time but is not equal to the target time, provide a notification screen of the first type by using the display and a vibration notification of the first type at regular intervals by using the vibrator.

11. The electronic device of claim 1, wherein the information is heartbeat information of a user of the electronic device, and
the processor is configured to:
obtain a current heart rate using a heartbeat sensor included in the electronic device,
compare the current heart rate with a target heart rate, and
provide the notification of the first type when the current heart rate is within a range of the target heart rate, the notification of the first type is changed based on a difference between the current heart rate and the target heart rate.

12. The electronic device of claim 1, wherein the information is location information of the electronic device, and
the processor is configured to:
obtain a current location of the electronic device,
compare the current location with a target location, and
provide the notification of the first type when the current location is within a distance with respect to the target location, the notification of the first type is changed based on a difference between the current location and the target location.

13. A notification providing method of an electronic device, the method comprising:
obtaining a current value of information stored in the electronic device;
comparing the current value with a target value of the information; and
providing a notification of a first type when the current value is within a range of the target value and is not equal to the target value.

14. The method of claim 13, further comprising:
changing the notification of the first type based on a difference between the current value and the target value.

15. The method of claim 14, wherein the changing of the notification comprises:
adjusting at least one or more of brightness, contrast, or hue of the notification of the first type, when the notification of the first type is a notification screen output through a display.

16. The method of claim 14, wherein the changing of the notification comprises:
changing at least one or more of intensity, a duration time, a period, or a frequency of the notification of the first type, when the notification of the first type is a sound notification output through a speaker.

17. The method of claim 14, wherein the changing of the notification comprises:
changing at least one or more of intensity, a duration time, a period, or a frequency of the notification of the first type, when the notification of the first type is a vibration notification output through a vibrator.

18. The method of claim 13, wherein the obtaining of the current value comprises:
obtaining the current value by sensing the information.

19. The method of claim 13, wherein the obtaining of the current value comprises:
obtaining the current value from an external device.

20. A computer-readable recording medium having recorded thereon an instruction, the instruction, which is executed by at least one processor, causing the processor to perform a method, the method comprising:
obtaining a current value of information stored in an electronic device;
comparing the current value with a target value of the information; and
providing a notification of a first type when the current value is within a range of the target value and is not equal to the target value.
